(19) United States
(12) Patent Application Publication
(10) Pub. No.: US 2005/0119051 A1
(43) Pub. Date: Jun. 2, 2005

(54) Dual-function remote controller capable of manipulating video game and method thereof

(76) Inventor: Seongho Ko, Seoul (KR)

Correspondence Address: JONES DAY, 222 EAST 41ST ST, NEW YORK, NY, 10017, US

(21) Appl. No.: 10/498,845

(22) PCT Filed: Dec. 14, 2001
(86) PCT No.: PCT/KR01/02171

(51) Int. Cl. G06F 17/00

(52) U.S. Cl. 463/37

(57) ABSTRACT

Disclosed is a remote control system for implementing computer games by connecting a remote controller for operating radio-controlled models to a computer device. The remote control system comprises: a computer device with game programs installed therein to implement a game based on operation data inputted from the remote controller; and a connecting means for connecting the remote controller to the computer device, wherein the remote controller transmits command data to the computer device according to a user's operation for the game offered by the computer device.

### FIELD OF THE INVENTION

The present invention relates to a remote controller, and more particularly to a remote control system and a method for implementing computer games by connecting a remote controller for operating a model car or a model plane to a computer.

### BACKGROUND OF THE INVENTION

Radio remote control of model cars or model planes has been one of the most popular hobbies in the world. People take pleasure in operating and controlling miniaturized model cars or model planes by radio.

However, radio-controlled (RC) model cars or planes are often crashed when operated by an inexperienced person or improperly operated. If the operator operates an RC model after sufficient practice with an operating simulation game, it will be possible to prevent the RC model from being crashed or damaged.

In order to play an operating or aviation simulation game on a computer, a separate input device for operating the RC model, such as a joystick or an operating input, should be connected to the computer. It is inconvenient and incurs an additional expense to purchase the separate input device.

### SUMMARY OF THE INVENTION

Therefore, the present invention has been made in view of the above-mentioned problems, and it is an object of the present invention to provide a remote control system and a method for operating both radio-controlled models and computer games by connecting a remote controller for operating radio-controlled models to a computer device.

In order to accomplish the objects of the present invention, there is provided a remote control system for implementing computer games by connecting a remote controller for operating radio-controlled models to a computer device, said remote control system comprising a computer device with game programs installed therein to implement a game based on operation data inputted from the remote controller and a connecting means for connecting the remote controller to the computer device, wherein the remote controller transmits command data to the computer device according to a user's operation for the game offered by the computer device.

According to another aspect of the present invention, there is provided a method of implementing a computer game by connecting a remote controller for operating radio-controlled models to a computer device, said method comprising the steps of: (a) connecting the remote controller to the computer device; (b) changing the operation mode of the remote controller to a mode for implementing a computer game; (c) executing a computer game program through the computer device; (d) implementing the computer game using the remote controller; (e) transmitting operation data outputted from the remote controller to the computer device; and (f) controlling the computer game on the computer device based on the operation data transmitted from the remote controller.

According to the present invention, a remote controller for operating radio-controlled models, such as model planes or model cars, can be connected to a computer device to implement computer games. Thus, without the need to purchase a separate input device, users can play an operation or aviation simulation game on the computer with a sense of presence using the remote controller, thereby improving their ability to operate RC models.

### BRIEF DESCRIPTION OF THE DRAWINGS

The foregoing and other objects, features and advantages of the present invention will become more apparent from the following detailed description when taken in conjunction with the accompanying drawings in which:

FIG. 1 shows the configuration of a remote control system having a computer game operating function according to the present invention;

FIG. 2 is a block diagram roughly showing the inside configuration of a computer device connected to a remote controller;

FIG. 3 is a block diagram roughly showing the inside configuration of a remote controller connected to a computer device;

FIG. 4 is a view roughly showing the inside configuration of a potentiometer;

FIG. 5 is a flow diagram showing the operation of a remote controller connected to a computer device according to one embodiment of the present invention;

FIG. 6 is a flow diagram showing the operation of a computer device connected to a remote controller; and

FIGS. 7 and 8 are flow diagrams showing the operation of a remote controller connected to a computer device according to another embodiment of the present invention.

### DETAILED DESCRIPTION OF THE PREFERRED EMBODIMENTS

Hereinafter, preferred embodiments of the present invention will be described with reference to the accompanying drawings.

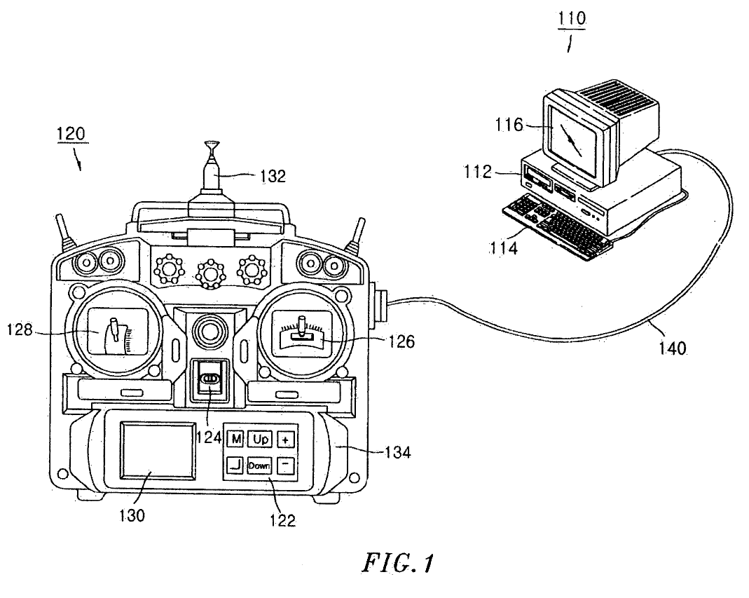

FIG. 1 shows the configuration of a remote control system having a computer game operating function according to the present invention. The remote control system of the present invention will mainly be described in relation to the implementation of a computer game for a model plane operating simulation as an example.

Referring to FIG. 1, the remote control system according to the present invention comprises: a computer device 110 for implementing a simulation game of operating model planes or cars; a remote controller 120 for transmitting command signals to the computer device 110 according to a user's operation for a simulation game or other games offered by the computer device 110; and a USB (Universal Serial Bus) cable 140 for connecting the computer device 110 to the remote controller 120.

The computer device 110 has various programs installed therein, including simulation game programs for practicing operation of radio-controlled models. The computer device 110 comprises: a mainframe 112 for implementing a simulation game or other games according to an operation command inputted from the remote controller 120; a keyboard 114 for selecting a game among a plurality of simulation games or inputting any other data; and a monitor 116 for displaying the state of a game implemented on the computer device 110.

The remote controller 120 comprises: an operation key panel 122 connected to the computer device 110 through the USB cable 130 and having a plurality of operation keys for selecting an operation mode such as a radio control mode; a power switch 124 for turning on or off power; a steering stick 126 for moving an RC model right or left; a throttle stick 128 for moving the RC model forward or backward; an LCD display 130 for displaying the operation state of the remote controller 120; an antenna 132 for sending a radio control signal; and a battery box 134 containing a battery (not shown) for supplying power necessary for the operation of the remote controller 120.

The battery box 134 contains a rechargeable battery from which power is supplied to each part of the remote controller through wires (not shown). The rechargeable battery is detachable.

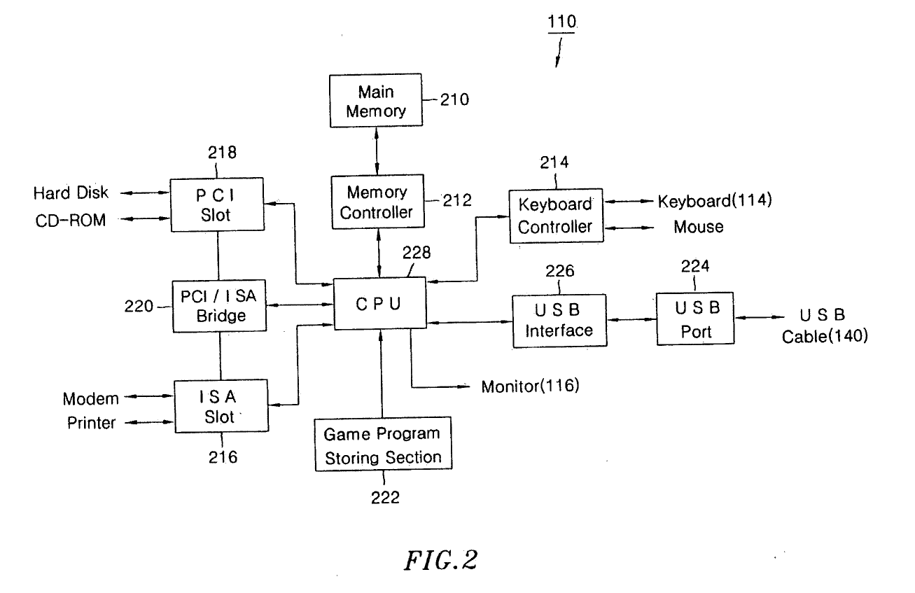

FIG. 2 is a block diagram roughly showing the inside configuration of the computer device 110.

The computer device 110 as shown in FIG. 2 comprises: a central processing unit (CPU) 228 for controlling the computer device as a whole and the implementation of games, according to command data inputted from the remote controller 120; a main memory 210 for storing various data and programs relating to the operation of the computer device 110; a memory controller 212 for controlling an access to the main memory 210 based on address data transmitted from the CPU 228; a keyboard controller 214 for controlling a keyboard or a mouse; an Industry Standard Architecture (ISA) slot 216 to which low-speed peripheral devices, such as a modem, a floppy disk drive and a printer, are connected; a PCI slot 218 to which high-speed peripheral devices, such as a hard disk driver and a CD-ROM, are connected; a PCI/ISA bridge 220 for controlling data receiving/transmission between the ISA slot 216 and the PCI slot 218; a game program storing section 222 for storing a plurality of game programs, including a simulation game program for operating a model plane or a model car; a USB port 224 connected to the USB cable 140; and a USB interface 226 for converting parallel data from the CPU 228 into serial data, outputting the serial data to the USB port 224 according to a clock frequency and converting the serial data received from the USB port 224 into parallel data.

The PCI/ISA bridge 220 includes a resistor for showing data input from the ISA slot 216 or the keyboard controller 214. If there is no data input for a particular period of time, the PCI/ISA bridge 220 will set a flag representing absence of data in a corresponding register.

Although not shown in the drawings, the CPU 228, the main memory 210 and the memory controller 212 are connected to each other through CPU buses, i.e., a CPU data bus and a CPU address bus. The keyboard controller 214, the ISA slot 216, the PCI slot 218 and the PCI/ISA bridge 220 are connected to each other through system buses, i.e., a system data bus and a system address bus.

Among the elements described above, the USB port 224, which connects the remote controller 120 to the computer device 110 in order to enable a user to implement a computer game using the remote controller 120, will be described below in more detail.

The USB port 224 was developed to unify interfaces widely applicable in general purpose computers to a single and standardized interface, thereby suppressing the development of unnecessary interfaces and solving the problem caused by the insufficient number of ports. The USB port is a serial port which drew special attention with the launch of Microsoft's Windows 98 system. Also, the USB port is a plug-and-play interface which connects peripherals, such as an audio player, joystick, keyboard, telephone, scanner and printer, to a computer.

Generally, the USB port supports hot-plug as well as plug-and-play. The “Plug-and-play” function enables a computer to automatically recognize peripherals connected to the mainframe 110 of the computer, while the “hot-plug” function enables peripherals to be connected to or disconnected from the mainframe 112 even during the operation of the computer, without the need to power off the computer.

It is often the case that a single still picture file has a size exceeding 100 megabytes. Further, a moving picture file or a music file generally consumes over hundreds of megabytes of storage space. It is difficult to receive or transmit large data files through existing serial or parallel ports. To solve this problem, a USB supports two transmission modes, i.e., low speed mode of 1.5 Mbps (megabyte per second) and high speed mode of 12 Mbps. The low speed mode is used for peripherals such as keyboards, mice and joysticks. The high-speed mode is used for hard disks, CD-ROMs, DVDs (digital video disks), digital cameras, zip drives, scanners, printers and so on.

A USB makes it possible to simultaneously use and connect up to 127 peripheral devices to a single bus. When existing serial ports or parallel ports are used, communication cables used to connect various peripheral devices to a computer are likely to be entangled with each other. A USB can clear up the back of the computer which is in a mess due to the entangled cables.

In order to connect up to 127 devices to a single bus, USB devices and a USB hub are used. Although not shown in the accompanying drawings, USB devices are connected to a USB hub through the USB cable 140 or directly to the USB port 224 of the mainframe of the computer. Up to 127 devices can be connected to a single USB bus. As stated above, different devices are used according to the transmission mode (low speed or high speed).

The USB hub is a device that enables a plurality of USB devices to jointly use a single output of a USB host. The USB hub determines whether any device is connected to a downstream port and detects the power amount required by each device. In addition, the USB hub determines whether the downstream port is set at low-speed mode or high-speed mode to process data.

The USB host is a center of all USB connections. As hardware, the USB host is termed a USB host controller. The USB host controller serves to manage and control a driver required by each peripheral device connected to the bus, software and data flow.

The USB cable 140 includes four physical communication cables. Two of these communication cables are used to transmit data between the remote controller 120 and the computer device 110, while the other two are used to supply power. If power is supplied directly to a device consuming less power through the USB bus, it will be possible to operate the device using a current supplied from the USB bus, without an external source of power. However, to operate a device that requires more current than that supplied by the USB bus, a separate power adapter should be used.

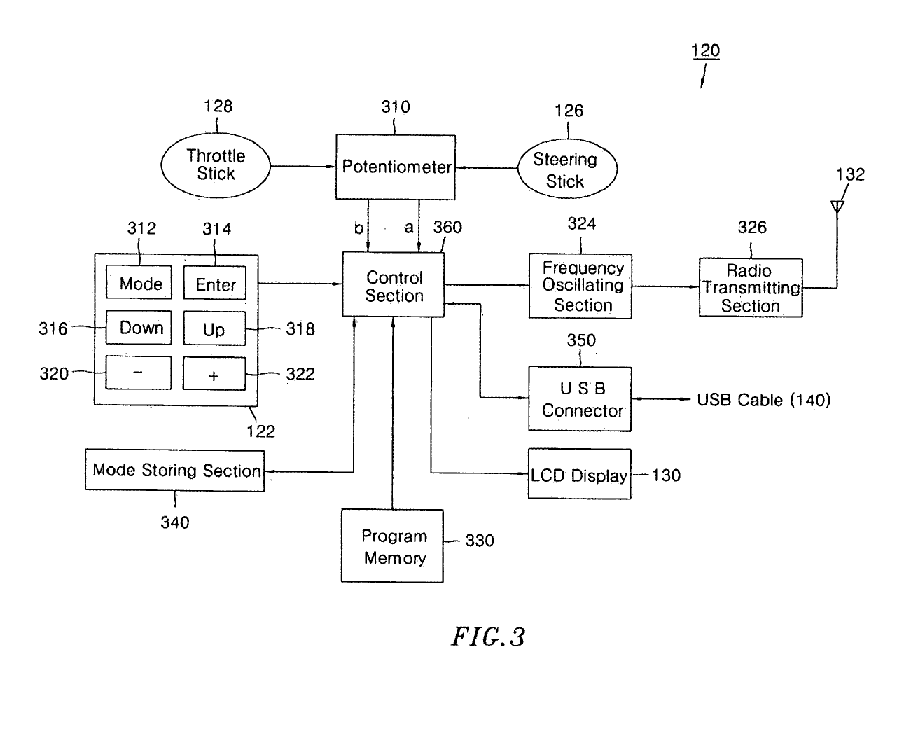

FIG. 3 is a block diagram roughly showing the inside configuration of a remote controller. The same reference numerals are used to designate the same elements as illustrated in FIG. 1, and a detailed description of the same is omitted.

Referring to FIG. 3, a potentiometer 310 generates a voltage signal based on the resistance according to the operation of the steering stick 126 and the throttle stick 128. The operation key panel 122 comprises a mode key 312 for selecting an operation mode of the remote controller 120, an enter key 314 for inputting a selection of an operation key, a down key 316 for moving a selection bar down on each menu, an up key 318 for moving a selection bar up on each menu, a reduction key for reducing various values and an increase key for increasing various values.

A frequency oscillating section 324 generates an oscillating frequency signal according to the key operation at the operation key panel 122. The frequency oscillating section 324 includes a crystal (not shown) required to generate the signal.

A radio transmitting section 326 removes noise from an oscillating frequency signal generated from the frequency oscillating section 324, amplifies the signal and outputs the amplified signal. The antenna 132 sends an amplified signal outputted from the radio transmitting section 326 as a radio signal.

Although not shown in the drawings, the radio transmitting section 326 comprises a first filter circuit for removing noise from an oscillating frequency signal generated from the frequency oscillating section 324, a second filter circuit for amplifying the frequency filtered at the first filter circuit and a third filter circuit for amplifying the frequency filtered at the second filter circuit.

A program memory 330 stores a program for operating the remote controller 120 as a game operator when power is supplied to the remote controller 120 from outside. When power is supplied through a USB connector 350, the program stored in the program memory 330 converts the operation mode of the remote controller into a mode for controlling external devices and sends only the potentiometer conversion values of the steering stick 126 and the throttle stick 128 to the computer device 110.

A mode storing section 340 stores a state flag, which represents a mode selected by the operation key panel 122. A control section 360 controls various functions based on modes stored in the mode storing section 340. Modes that can be stored as state flags in the mode storing section 340 include a system mode for setting the system of the remote controller 120, a pit mode for setting functions required to operate a model car, and a circuit mode for setting functions required during the operation of the model car.

The USB connector 350 is connected to the USB cable 140 for connecting the remote controller to the computer device 110. When power is supplied from outside, the control section 360 controls a voltage signal generated from the potentiometer 310 by the operation of the steering stick 126 and the throttle stick 128 to be outputted as operation data to the USB connector 350 according to the program stored in the program memory 330.

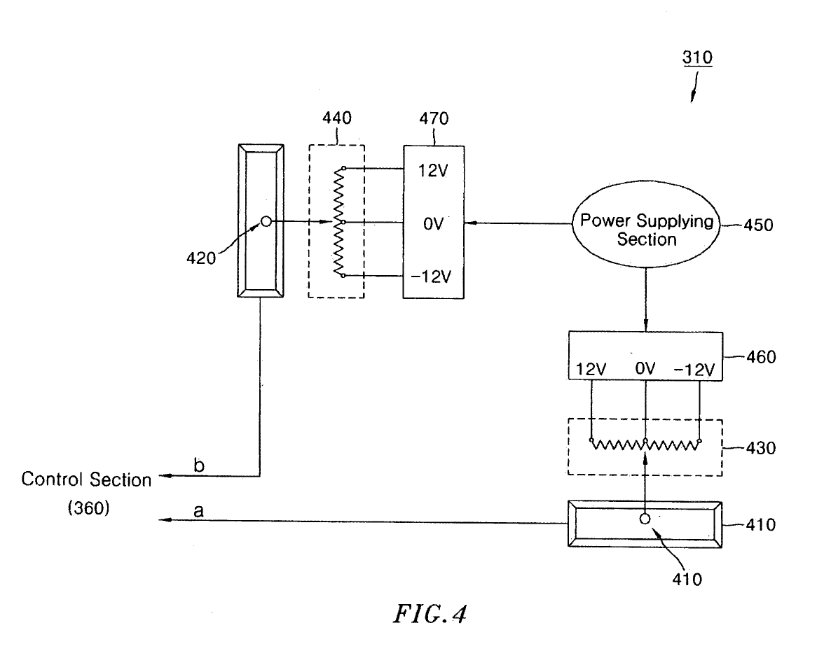

FIG. 4 is a view roughly showing the configuration of the potentiometer 310.

The potentiometer 310 is a variable resistor which is used to allow a change in the resistance by a slider moving between resistive terminals connected to the power and to generate a variable voltage signal. Potentiometers are usually divided into two basic types, rotary and slider, according to the structure driving the movable slider. The rotary type potentiometer provides a variable resistance output from 0 ohms to several K ohms according to the mechanical angle of rotation of the slider, whereas the slider type potentiometer provides a variable resistance output from 0 ohms to several K ohms according to the mechanical range of travel (displacement) of the slider.

The potentiometer 310 comprises: a steering slider 410 for changing a resistance by its movement according to the operation of the steering stick 126; a throttle slider 420 for changing a resistance by its movement according to the operation of the throttle stick 128; a first variable resistor 430 for generating a resistance corresponding to the left-right movement of the steering slider 410; a second variable resistor 440 for generating a resistance corresponding to the forward-backward movement of the throttle slider 420; a power supplying section 450 for supplying power necessary for the operation of the potentiometer 310; a first power interface 460 for generating a voltage signal corresponding to the resistance of the first variable resistor 430 at the power supplied from the power supplying section 450; and a second power interface 470 for generating a voltage signal corresponding to the resistance of the second variable resistor 440 at the power supplied from the power supplying section 450.

In the potentiometer 310 having the above configuration, the steering slider 410 in the steering stick 126 or the throttle slider 420 in the throttle stick 128 moves to change the resistance of the first variable resistor 430 or the second variable resistor 440, when a user moves the steering stick 126 or the throttle stick 128. Accordingly, the first power interface 460 and the second power interface 470 generate voltage signals which are applied to the control section 360 through line a and line b, respectively. The control section 360 recognizes the voltage signals applied from the potentiometer 310 and outputs corresponding signals for left-right operation and forward-backward operation as digital signals to the USB connector 350.

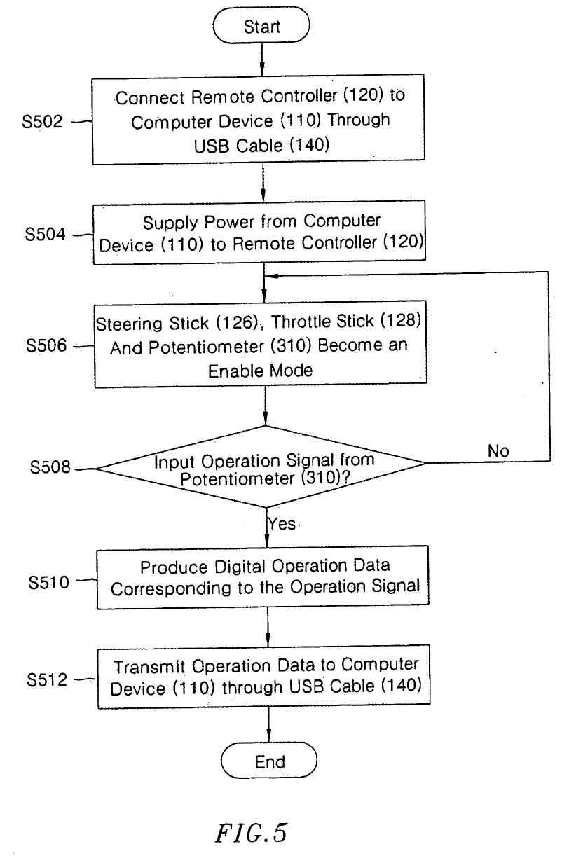

The operation of the remote control system having a computer game operating function will be described in more detail with reference to FIGS. 5, 6 and 7.

FIG. 5 is a flow diagram showing the operation of the remote controller 120 according to one embodiment of the present invention.

The user can connect the remote controller 120 to the computer device 110 by connecting one end of the USB cable 140 to the USB port of the computer device 110, which is powered on, and the other end of the USB cable 140 to the USB connector 350 of the remote controller 120 (step S502).

When the remote controller 120 is connected to the computer device 110 through the USB cable 140, power is supplied to the remote controller 120 from the computer device 110 through a power line (not shown) of the USB cable 140 connected to the computer device 110 (step S504).

The power is then supplied to all parts of the remote controller 120. Accordingly, the steering stick 126, throttle stick 128 and potentiometer 310 become an enable state. The control section 360 is changed to a mode for controlling external devices and goes into a waiting state for converting an operation signal applied from the potentiometer 310 into data and sending the data (step S506).

The user implements a car-driving simulation game using the computer device 110, and then inputs an operation key to play the simulation game by operating the steering stick 126 and throttle stick 128 of the remote controller 120. When the steering stick 126 and the throttle stick 128 are operated, the steering slider 410 in the steering stick 126 and the throttle slider 420 in the throttle stick 128 slidably move to change the resistance of each of the first variable resistor 430 and the second variable resistor 440. As a result, voltage signals are generated from the first power interface 460 and the second power interface 470 and applied to the control section 360 through line a and line b, respectively.

When the voltage signals, i.e., operation signals, applied from the potentiometer 310 are inputted (step S508), the control section 360 generates corresponding signals for left-right operation and forward-backward operation as digital operation data (step S510). The operation data is outputted to the USB connector 350 and then transmitted to the computer device 110 through the USB cable 140 (step S512).

The CPU 228 of the computer device 110 implements a control function corresponding to the operation data received from the remote controller 120 based on the simulation program. After going through the above steps, the user can implement the simulation program for operating a model car.

When the user finishes playing the simulation game using the computer device 110, the USB cable 140 is disconnected from the USB connector 350.

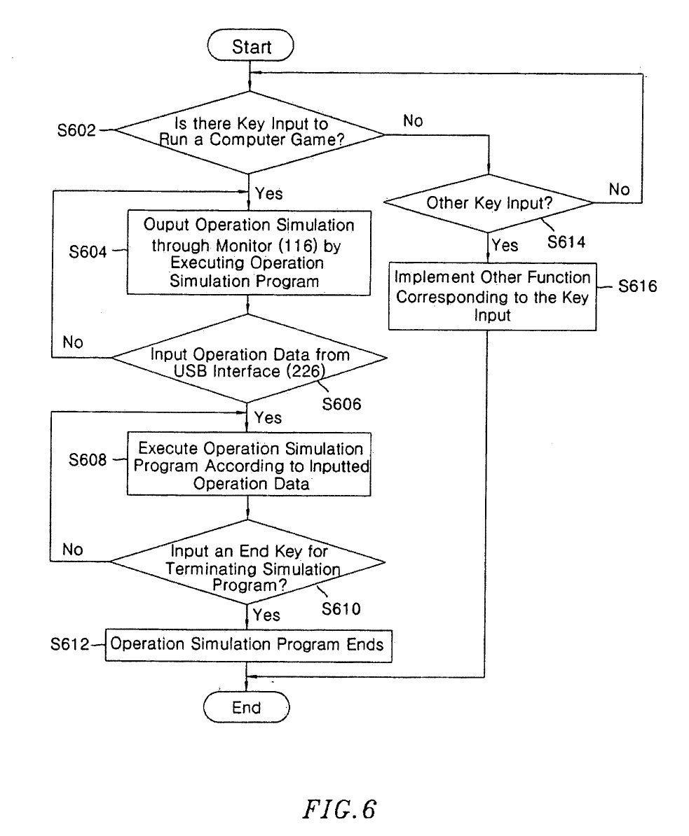

FIG. 6 is a flow diagram showing the operation of the computer device 110.

The user can power the computer device 110 according to a general control operation.

After powering the computer device 110, the user can select and implement a car-driving simulation game, among a plurality of game programs installed in the computer device 110, using the mouse or the keyboard 114 (step S602).

According to the command to implement the car-driving simulation game, which was inputted by the mouse or the keyboard 114, the CPU 228 implements a simulation program (222) and outputs a picture of the car-driving simulation game through the monitor 116 (step S604).

After selecting various functions necessary to play the car-driving simulation game according to the simulation program 222 in the computer device 110, the user can operate the remote controller 120 connected to the computer device 110 to drive a car through the simulation game.

The operation data according to the car-driving is transmitted to the USB port 224 through the USB cable 140. When the operation data is inputted from the USB interface 226 via the USB port 224 (step S606), the CPU 228 implements the simulation game program according to the inputted operation data (step S608).

More specifically, if the user moves the steering stick 126 of the remote controller 120 connected to the computer device 110 to the left, the car on the car-driving simulation game will make a left turn. If the steering stick 126 is moved right, the car on the car-driving simulation game will make a right turn. If the user slowly pushes the throttle stick 128 forward, the car will gradually speed up. If the user slowly pulls the throttle stick 128 downward, the car will gradually slow down.

The user can finish the car-driving simulation game using the mouse or the keyboard 114. When a key for finishing the simulation game program is inputted from the mouse or the keyboard 114 (step S610), the CPU 228 terminates the simulation game program and returns to a general computer control mode (step S612).

If a key for any function other than computer games is inputted at step S602, for example, if a key for document preparation or Web access is inputted (step S614), the CPU 228 will implement the function corresponding to the key input (step S616).

According to the first embodiment of the present invention, when the remote controller 120 is connected to the computer device 110 through the USB cable 140, power is supplied to the remote controller 120 from the computer device 110. Then, only the steering stick 126 and throttle stick 128 of the remote controller 120 can be operated, while the other key input buttons of the remote controller 120 do not work. Operation data generated by the operation of the steering stick 126 and the throttle stick 128 is transmitted to the computer device 110 so that the remote controller 120 can be used to implement simulation games on the computer device 110.

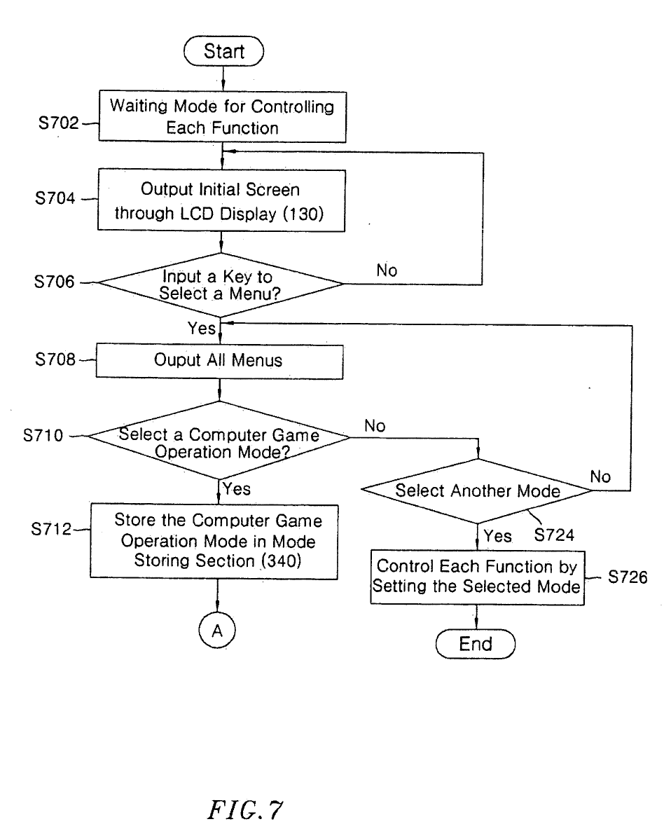

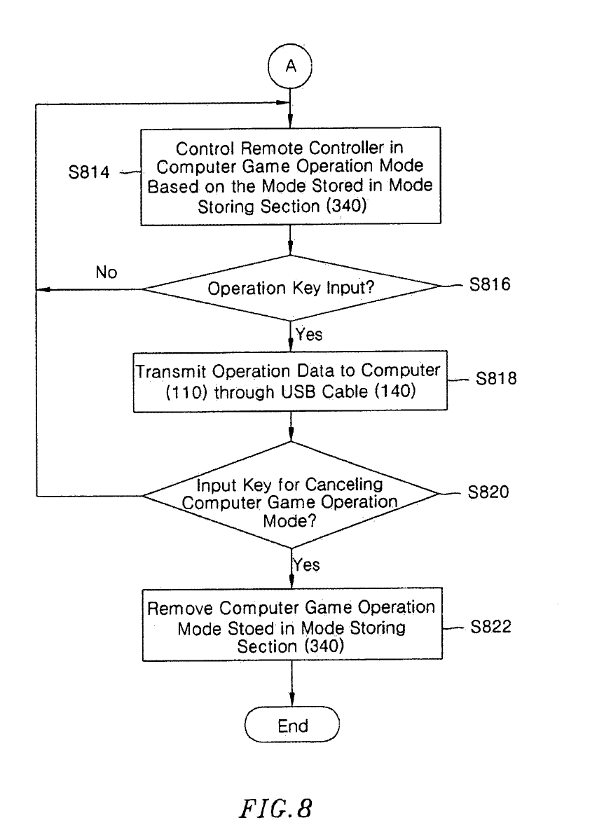

FIG. 7 is a flow diagram showing the operation of the remote controller 120 according to the second embodiment of the present invention.

According to the second embodiment, the operation key panel 122 comprises the mode key 312 for selecting a computer game operation mode. In system mode state, the computer game operation mode can be selected from various menus.

The program memory 330 stores a program for operating the remote controller 120 as a simulation game operator. The program memory 330 selects button operation values and potentiometer conversion values of the steering stick 126 and the throttle stick 128 and sends the values to the computer device 110. Also, when power is supplied through a USB connector 350, the program memory 330 converts the mode for controlling internal devices into a mode for controlling external devices.

When power is supplied to the remote controller 120 from the computer device 110, the control section 360 is changed to a mode for controlling external devices and becomes a waiting state for controlling each function (step S702).

Also, the control section 360, when powered up, outputs an initial screen displaying the model number, model name, applicable power voltage, frequency, remaining power, etc. of a radio-controlled model car or plane through the LCD display 130 (step S704).

Among items displayed on the initial screen, the model number matches each RC model operated by the remote controller 120 with a corresponding driving frequency. A unique model number assigned to each RC model is displayed when the RC model is operated. The model name is the name of an RC model corresponding to each model number. The remaining power is shown by a bar in order for the user to confirm the consumption of power necessary for the operation of the remote controller 120. The power voltage refers to the voltage required to operate the remote controller 120. The remaining power can be shown by a bar graph.

On the initial screen, the user can set a desired operation mode by inputting the operation keys provided on the operation key panel 122. In the present invention, it is possible to set a system mode by simultaneously inputting the reduction key 320, increase key 322 and enter key 314 according to the program stored in the program memory 330. However, the system mode can be set by another key input, without using the reduction key 320, increase key 322 and enter key 314.

The system mode is a mode for model name input, trim rate and frequency setting, data copy, LCD brightness control or the like. Model name, which is a unique name assigned to each RC model, is used to select an RC model that the user wishes to operate from a list of inputted models.

If a list of all functions cannot be fully displayed on the LCD display 130, the control section 360 generates a scroll bar on the right side of the display screen. The user can see the functions which are not displayed on the present display screen by moving down the scroll bar.

Trim rate setting is a menu for setting the unit of data input for adjusting the neutral position of the servo mounted within a model car at the neutral position where the steering stick 126 and the throttle stick 128 do not work. If the trim rate is set to be “1,” the neutral position will be moved by 1 each time when the reduction key 320 or the increase key 322 is pressed. If the trim rate is set to be one of “2 to 10,” the neutral position will be moved by the unit of said one of 2 to 10 each time when the reduction key 320 or the increase key 322 is pressed.

Data copy is a menu for copying the model name of an RC model which receives a signal outputted from the remote controller 120. A model name that has been set and related data can be copied to another model number which is empty and idle.

If the user inputs a key to select a menu on the operation key panel 122 by inputting the enter key 314 while pressing the reduction key 320 and the increase key 322 simultaneously (step S706), the control section 360 will output mode selection menus, such as model name selection, trim rate setting, data copy and game operation, on the LCD display 130 (step S708).

If, for example, a car-driving simulation game is implemented by the computer device 110, the user can select a computer game operation mode to use the remote controller 120 as a car-driving simulation game operator by positioning a selection bar at the computer game operation menu, among a plurality of menus displayed on the LCD display 130, using the up key 318 and the down key 316, and inputting the enter key 314.

When the computer game operation mode is selected by the user's key input (step S710), the control section 360 stores a state flag relating to the computer game operation, thereby changing the mode of the remote controller 120 to a computer game operation mode (step S712).

The control section 360 controls all parts of the remote controller 120, including the steering stick 126, throttle stick 128 and operation key panel 122, under the computer game operation mode based on the modes stored in the mode storing section 340 (step S714).

In the computer game operation mode, operation data inputted by the operation of the steering stick 126 and the throttle stick 128 is transmitted to the computer device 110 through the USB cable 140 connected to the USB connector 350. In this mode, the LCD display 130 displays the present state (computer game operation mode) of the remote controller 120.

If the user moves the steering stick 126 to the left in the computer game operation mode, the car on the car-driving simulation game implemented by the computer device 110 connected to the remote controller 120 will make a left turn. If the steering stick 126 is moved right, the car on the car-driving simulation game will make a right turn.

In addition, if the user slowly pushes the throttle stick 128 forward in the computer game operation mode, the car will gradually speed up. If the user slowly pulls the throttle stick 128 backward, the car will gradually speed down.

To finish playing the simulation game using the computer device 110, the user should input a key for disconnecting the USB cable 140 from the USB connector 350 and canceling the computer game operation mode using the operation key panel 122.

When a key for canceling the computer game operation mode is inputted from the operation key panel 122 (step S720), the control section 360 removes the game operation mode stored in the mode storing section 340 (step S722).

If the user selects any other mode than the computer game operation mode at step S710, for example, if a pit mode for setting functions required to operate a model car before operation of the model car or a circuit mode for setting required functions during operation of the model car is inputted by the user's key input (step S724), the control section 360 will set the selected mode and control each function of the selected mode (step S726).

The pit mode refers to a mode for setting functions, such as a function of selecting a model of an RC model car, a function of selecting a level set for inexperienced beginners, a servo direction selecting function for moving a model car left or right or controlling the direction or speed of a turning car, and a sub trim function for designating the neutral position of a servo. The circuit mode refers to a mode for setting functions, such as an end point adjusting function for designating the maximum operational position of a servo, a response function for adjusting a rate reflecting the operation angle of the servo according to the operation of a handle, a steering speed function for setting the servo operation speed corresponding to the handle operation speed, and an ABS (anti-lock brake system) function for improving the braking function by repeating the operation that a brake pad locks and unlocks a lining according to an inputted value during braking by the servo.

According to the second embodiment of the present invention, the user can convert the operation mode of the remote controller 120 into a computer game operation mode using the function keys provided on the operation key panel 122 of the remote controller 120 so that the remote controller 120 can be used as a game operator for implementing a computer game.

After connecting the remote controller 120 for operating radio-controlled model cars or planes to the computer device 110 through the USB cable 140, the user can play a computer game by operating the remote controller 120 according to the game implemented by the computer device 110. The present invention provides a remote control system and a method for implementing a computer game using the remote controller.

As can be seen from the foregoing, the remote control system and method for implementing computer games according to the present invention can be utilized not only to operate radio-controlled model cars, planes or boats, but also to implement various software Internet games. The remote controller according to the present invention, if connected to a computer, can be used as a computer game operator.

While this invention has been described in connection with what is presently considered to be the most practical and preferred embodiment, it is to be understood that the invention is not limited to the disclosed embodiment and the drawings, but, on the contrary, it is intended to cover various modifications and variations within the spirit and scope of the appended claims.

1. A remote control system for implementing computer games by connecting a remote controller for operating radio-controlled models to a computer device, the remote control system comprising:
a computer device having game programs installed therein to implement a game based on operation data inputted from the remote controller; and
a connecting means for connecting the remote controller to the computer device,
wherein the remote controller transmits command data to the computer device according to a user's operation for the game offered by the computer device.

2. The remote control system according to claim 1, wherein the connecting means is a USB (Universal Serial Bus) cable.

3. The remote control system according to claim 1, wherein the computer device has various programs installed therein, including simulation game programs for practicing operation of radio-controlled models, and comprises a mainframe for implementing a simulation game or other games according to an operation command inputted from the remote controller, a key input means for selecting one of a plurality of games or inputting any other data, and a monitor for visually displaying the state of a game implemented.

4. The remote control system according to claim 1, wherein the mainframe of the computer device comprises: a central processing unit (CPU) for controlling the computer device as a whole and the implementation of a simulation game according to command data inputted from the remote controller; a main memory for storing various data and programs relating to the operation of the computer device; a simulation game program storing section for storing a program of the simulation game for operating an RC model; a USB port connected to a USB cable; and a USB interface for converting parallel data from the CPU into serial data, outputting the serial data to the USB port according to a clock frequency and converting the serial data received from the USB port into parallel data.

5. The remote control system according to claim 1, wherein the remote controller comprises:
an operation key panel having a plurality of operation keys for selecting an operation mode, such as a radio control mode or a computer game operation mode;
a steering stick for moving an RC model right or left;
a throttle stick for moving the RC model forward or backward;
a potentiometer for generating a voltage signal based on a resistance according to the operation of the steering stick and the throttle stick;
a frequency oscillating section for generating an oscillating frequency signal according to the key operation at the operation key panel;
a raid transmitting section for removing noise from a frequency generated from the frequency oscillating section, amplifying the frequency and transmitting the amplified frequency;
an antenna for sending the frequency outputted from the raid transmitting section as a radio signal;
an LCD display 130 for displaying the operation state of the remote controller;
a program memory for storing a program for operating the remote controller as a game operator;
a mode storing section for storing a mode selected by the operation key panel in a state flag;
a control section for controlling the operation of the RC model or the implementation of a game on the computer device according to the operation data inputted from the operation key panel; and
a USB connector connected to the USB cable in order to connect the remote controller to the computer device.

6. The remote control system according to claim 5, wherein the program memory stores a program for selecting only button operation values and potentiometer conversion values of the steering stick and the throttle stick and sending the values to the computer device and a program for converting the mode for controlling internal devices into a mode for controlling external devices, when power is supplied through the USB connector.

7. A method for implementing a computer game by connecting a remote controller for operating radio-controlled models to a computer device, the method comprising the steps of:
(a) connecting the remote controller to the computer device;
(b) changing the operation mode of the remote controller to a mode for implementing a computer game;
(c) executing a computer game program through the computer device;
(d) implementing the computer game using the remote controller;
(e) transmitting operation data outputted from the remote controller to the computer device; and
(f) controlling the computer game on the computer device based on the operation data transmitted from the remote controller.

8. The method according to claim 7, wherein, in step (a), the remote controller is connected to the computer device through a USB (Universal Serial Bus) cable.

9. The method according to claim 7, wherein the computer game program in step (c) is a simulation game for operating an RC model.

10. The method according to claim 7, wherein, in implementing the computer game in step (d), a model on the computer game is operated to move forward, backward, leftward, and rightward, and the speed of the model is controlled using the operation keys provided on the remote controller.

11. The method according to claim 7, wherein, in step (e), button operation values and potentiometer conversion values selected in the remote controller are sent to the computer device.
